(19) United States
(12) Patent Application Publication
(10) Pub. No.: US 2011/0315263 A1
(43) Pub. Date: Dec. 29, 2011

(54) FLEXIBLE COMPOSITE PIPE

(76) Inventors: Christopher A. Bertelo, Doylestown, PA (US); Anthony Decarmine, Lebanon, CT (US)

(21) Appl. No.: 13/147,443

(22) PCT Filed: Feb. 2, 2010
(86) PCT No.: PCT/US10/22797

§ 371 Date: Sep. 7, 2011

Related U.S. Application Data
(60) Provisional application No. 61/149,112, filed on Feb. 2, 2009.

(51) Int. Cl. F16L 11/00; B32B 1/08

(52) U.S. Cl. 138/137; 428/36.91

(57) ABSTRACT

A flexible composite pipe useful in off-shore oil and gas well operations is provided which contains at least one polymer layer such as an internal pressure sheath, an intermediate sheath, an anti-wear layer and/or an outer sheath, wherein the polymer layer is formed using a polyetherketoneketone or mixture of polyetherketoneketones having a controlled ratio of different isomeric repeating units.

### FIELD OF THE INVENTION

The invention relates to the use of a polyetherketoneketone or mixture of polyetherketoneketones having a controlled ratio of different isomeric repeating units to provide a relatively ductile, yet strong and heat resistant polymer layer in a composite pipe that is capable of being spooled onto a reel for storage and used in off-shore oil and gas field applications.

### DISCUSSION OF THE RELATED ART

Flexible piping, that is, piping capable of being wound upon a reel (sometimes also referred to as “spoolable tubing”), is commonly used in various oil and gas well operations. Typical oil and gas well operations include running wire line cable down oil or gas holes with well tools, working wells by delivering various substances down hole, and performing operations on the interior surface of the drill hole. For example, flexible piping is used to carry process chemicals back and forth from wells at the bottom of the ocean to floating platforms at sea level. The piping should be spoolable so that it can be wound on a reel as it is manufactured and then unspooled at the location where the piping is to be deployed. Additionally, spoolable piping can be conveniently transported to and used in conjunction with one well and then rewound on a reel and transported to another site and deployed again. Although the piping must be flexible, it must also generally be able to withstand high stress, pressure, and exposure to harsh conditions. Because of these rigorous performance requirements, the flexible piping used in such applications today typically has a composite structure, i.e., multiple layers comprised of different materials including metals and various types of plastics, which may be reinforced with glass or carbon fibers and the like.

Flexible tubular pipes useful for such purposes are addressed, for example, in documents API 17J and API RP 17B published by the American Petroleum Institute (API). This type of pipe contains successive layers that are independent of one another with one or more layers being helical windings of tapes and/or of profiled metal wires or bands and one or more layers being polymeric sheaths. The metal layers generally have the function of taking up the mechanical forces, both internal and external, while the polymer sheaths generally have the functions of providing internal or external sealing and/or providing abrasion resistance between metal layers. These various layers are to a certain extent movable with respect to one another so as to allow the pipe to bend. For example, adjacent layers may not be bonded or adhered to each other, thereby allowing them to slide over each other as the pipe is flexed. Various structures exist for such pipes, however they all generally have a multilayer assembly called a pressure vault, intended to take up the radial forces, and a multilayer assembly intended to take up the axial forces. Usually, the pressure vault located on the inside of the pipe consists of a short-pitch helical winding of a profiled wire, and the layers intended to take up the axial forces, located on the outside of the pipe, generally consist of a pair of armor plies consisting of crossed wires wound helically with a long pitch. Furthermore, to prevent at least two of these armor plies from being directly in contact with each other, something which would cause them to wear prematurely, a relatively thin intermediate layer of plastic is interposed (often referred to as an “anti-wear layer”).

A number of different types of polymers have been proposed for use in such anti-wear layers in flexible composite pipes. For example, published United States application US 2008-0190507 describes an anti-wear layer produced by helically winding a plastic material strip where the plastic material comprises an amorphous polymer having a glass transition temperature ranging from 175 to 255 degrees C. The amorphous polymer preferably contains sulphone groups, e.g., a polyphenylsulphone (PPSU). Published PCT application WO 2008/119677, on the other hand, proposes the use of a blend of a poly(aryl ether ketone) and a poly(aryl ether sulfone). Although such blends are said to have satisfactory properties, unless the two polymers employed are sufficiently compatible or miscible with each other such that a true polymeric alloy is obtained, under the extreme conditions to which the flexible pipe will be exposed it is likely that such polymers will ultimately phase separate. Such phase separation will adversely affect the performance and properties of the anti-wear layer fabricated from such blends.

### BRIEF SUMMARY OF THE INVENTION

The present invention provides a flexible composite pipe comprising a plurality of layers. The pipe includes at least one polymer layer that is comprised of an amorphous to semi-crystalline polyetherketoneketone or polyetherketoneketone mixture containing repeating units represented by Formula I and Formula II:

-A-C(═O)—B—C(═O)— I

-A-C(═O)-D-C(═O)— II

where A is a p,p′-Ph-O-Ph- group, Ph is a phenylene radical, B is p-phenylene, and D is m-phenylene. The Formula I:Formula II ratio is selected so as to impart sufficient ductility to said polymer layer to permit the flexible composite pipe to be wound on a spool without cracking.

### DETAILED DESCRIPTION OF CERTAIN EMBODIMENTS OF THE INVENTION

Flexible pipes in accordance with the present invention are advantageously manufactured using a polyetherketoneketone or a mixture of polyetherketoneketones which imparts sufficient ductility to a polymer layer within the flexible pipe to permit the flexible pipe to be wound on a spool without cracking of the polymer layer. Preferably, the polymer layer does not contain any polymer other than the polyetherketoneketone(s) and/or does not contain any plasticizer. The polymer layer containing the polyetherketoneketone may be an internal pressure sheath, an intermediate sheath, an anti-wear layer and/or an outer sheath of the flexible composite pipe.

The polyetherketoneketones suitable for use in the present invention contain (and preferably consist essentially of) repeating units represented by the following Formulas I and II:

-A-C(═O)—B—C(═O)— I

-A-C(═O)-D-C(═O)— II

where A is a p,p′-Ph-O-Ph- group, Ph is a phenylene radical, B is p-phenylene, and D is m-phenylene. The Formula I:Formula II ratio is selected so as to impart sufficient ductility to said polymer layer to permit the flexible composite pipe to be wound on a spool without cracking. In one embodiment, the crystallinity of the polyetherketoneketone or mixture of polyetherketoneketones, as measured by differential scanning calorimetry (DSC) and assuming that the theoretical enthalpy of 100% crystalline polyetherketoneketone is 130 J/g, is from 0 to about 50%. In another embodiment, the polyetherketoneketone crystallinity is from 0 to about 20%.

Polyetherketoneketones are well-known in the art and can be prepared using any suitable polymerization technique, including the methods described in the following patents, each of which is incorporated herein by reference in its entirety for all purposes: U.S. Pat. Nos. 3,065,205; 3,441,538; 3,442,857; 3,516,966; 4,704,448; 4,816,556; and 6,177,518. Mixtures of polyetherketoneketones may be employed.

In particular, the Formula I:Formula II ratio (sometimes referred to in the art as the T/I ratio) can be adjusted as desired by varying the relative amounts of the different monomers used to prepare the polyetherketoneketone. For example, a polyetherketoneketone may be synthesizing by reacting a mixture of terephthaloyl chloride and isophthaloyl chloride with diphenyl ether. Increasing the amount of terephthaloyl chloride relative to the amount of isophthaloyl chloride will increase the Formula I:Formula II (T/I) ratio.

In another embodiment of the invention, a mixture of polyetherketoneketones is employed containing polyetherketoneketones having different Formula I to Formula II ratios. For example, a polyetherketoneketone having a T/I ratio of 80:20 may be blended with a polyetherketoneketone having a T/I ratio of 60:40, with the relative proportions being selected to provide a polyetherketoneketone mixture having the balance of properties desired for the polymer layer to be used in the flexible composite pipe. This approach can be used to optimize or adjust the ductility as well as strength/temperature resistance properties of the polymer layer as may be desired for a particular application. Higher amorphous content (which can be achieved by blending or polymerization) generally yields higher ductility, while higher crystalline content yields higher strength at elevated temperatures. Using a blend of polyetherketoneketones of different crystallinities, rather than a combination of polymers having different chemical compositions, yields a higher integrity polymer layer which does not exhibit the incompatibility and loss of performance issues that can often occur when different polymers are combined.

Generally speaking, a polyetherketoneketone having a relatively high Formula I:Formula II ratio will be more crystalline than a polyetherketoneketone having a lower Formula I:Formula II ratio. The ductility and other mechanical, thermal, thermomechanical and other properties of the polyetherketoneketone and the polymer layer or polymer layers comprising the polyetherketoneketone can be varied as desired by controlling the crystallinity, thereby avoiding the need to blend in other polymers or plasticizers (which, as previously noted, can lead to phase separation problems).

Table 1 demonstrates the effect of varying the Formula I:Formula II ratio on the various properties of two representative polyetherketoneketones.

TABLE 1

| | | I:II Ratio = | I:II Ratio = |
|---|---|---|---|
| Property | Test Method | 60:40 | 80:20 |
| Crystallinity | DSC | None* | 30-35 |
| Water Absorption | ASTM D570 | <0.2 | <0.3 |
| @ 24 hr., % | | | |
| Tensile Strength | ASTM D638 | 13 | 16 |
| (Break), Kpsi | | | |
| Tensile Modulus, | ASTM D638 | 0.5 | 0.64 |
| Mpsi | | | |
| Elongation (Break), % | ASTM D638 | >80 | 12 |
| Flexural Strength | ASTM D570 | 20 | 28 |
| (Yield), Kpsi | | | |
| Flexural Modulus, | ASTM D570 | 0.49 | 0.66 |
| Mpsi | | | |
| Izod, Notched, ft- | ASTM D256 | 0.9 | 1.3 |
| lb/in | | | |
| Compressive | ASTM D695 | 15 | 30 |
| Strength, Kpsi | | | |
| Coefficient of | ASTM D1894 | 0.186 | 0.173 |
| Friction | | | |
| Coefficient of | ASTM D1894 | 0.285 | 0.262 |
| Friction, Static | | | |
| Melting Point, ° F. | DSC | 585 | 680 |
| Tg, ° F. | DSC | 310 | 325 |
| Melt Index, g/10 min | 8.4 kg at 380° C. | 35-45 | 100-120 |
| Flammability | UL94 | V-0 | V-0 |
| Rating | | | |
| HDT @ 264 psi, ° F. | ASTM D648 | 286 | 347 |

*technically, this polymer is semi-crystalline, but due to its very slow crystallization rate it is regarded as amorphous in terms of conventional processing techniques.

As can be seen from Table 1, if a more ductile polymer layer is desired (thereby enhancing the ability of the polymer layer in the composite pipe to flex or bend without cracking), the ratio of Formula Ito Formula II repeating units in the polyetherketoneketone should be decreased, as reflected in the substantial increase in the % elongation at break when such ratio is changed from 80:20 to 60:40. If, on the other hand, it is desired to increase the strength of the polymer layer, then the Formula I to Formula II ratio should be selected to be a relatively high value (the compressive strength observed at an 80:20 ratio is much higher than the compressive strength where the ratio is 60:40).

Suitable polyetherketoneketones are available from commercial sources, such as, for example, the polyetherketoneketones sold under the brand name OXPEKK by Oxford Performance Materials, Enfield, Conn., including OXPEKK-C and OXPEKK-SP polyetherketoneketone.

In certain embodiments of the invention, the polyetherketoneketone or polyetherketoneketone mixture has a Tg of from about 150 to about 180 degrees C.

Polyetherketoneketones generally exhibit exceptionally good creep (deformation under load) resistance and thus the polymer layers prepared using polyetherketoneketone in accordance with the present invention need not include fillers or fibers. Accordingly, in one embodiment of the invention, the polymer layer is free of fillers and/or fibers. However, if so desired in order to further enhance creep resistance, friction and wear resistance or other mechanical properties, the polymer layer may further comprise varying amounts of fillers and/or fibers, e.g., up to 5, 10, 15, 20, 25, or 30 weight percent filler and/or fiber or even more. Suitable fibers include glass fibers, carbon fibers (including graphite fibers), synthetic polymer fibers (e.g., polyester fibers, polyaramid fibers, polyamide fibers), inorganic fibers (e.g., boron fibers), metal fibers (e.g., steel fibers), carbon nanotubes, mineral nanotubes and the like. The fibers may be sized to improve interfacial adhesion between the fiber and the polyetherketoneketone, but sizing may not be needed as polyetherketoneketone has been found to provide good wetting of many fiber surfaces when admixed in the melt with fibers.

The flexible composite pipe of the present invention is preferably tubular, having a substantially round cross-sectional shape. If the pipe is to be utilized for transporting or conveying a gas or liquid, it will preferably comprise a hollow generally circular section through which the gas or liquid can be passed. The flexible composite pipe comprises a plurality of layers, including at least one polymer layer comprising a polyetherketoneketone in accordance with the present invention as well as at least one additional layer which may be an additional polymer layer (which may or may not be comprised of a polyetherketoneketone) or a metal layer (such as an armoring layer). Preferably, at least some of the layers are independent from each other (e.g., adjacent layers that are not bonded or adhered to each other). In one embodiment, all the layers are capable of moving independently from the layer or layers immediately adjacent to them. The presence of such independent, unbonded layers permits the layers to move relative to each other as the pipe is bent or flexed.

The flexible composite pipe may comprise a polymer layer containing polyetherketoneketone which is the innermost layer of the pipe, i.e., the layer that will form the inner surface of the pipe that is in contact with the gas or liquid being transported through the pipe. A polymer layer containing polyetherketoneketone may also or alternatively be the outermost layer of the flexible composite pipe, i.e., the layer that will form the outer surface of the pipe that is in contact with the environment surrounding the pipe (e.g., seawater, where the flexible composite pipe is being utilized in an offshore oil or gas well operation). The flexible composite pipe may also or alternatively comprise one or a plurality of intermediate polymer layers containing polyetherketoneketone in accordance with the present invention which are positioned between the outermost and innermost layers of the pipe.

In one embodiment, the flexible composite pipe comprises at least one armoring layer adjacent to a polymer layer containing polyetherketoneketone. In another embodiment, the flexible composite pipe comprises at least two armoring layers separated by a polymer layer containing polyetherketoneketone, wherein the polymer layer may function as an anti-wear layer (preventing the armoring layers from contacting each other and rubbing together as the pipe is coiled or flexed, which might result in abrasion of and weakening of the armoring layers). Typically, the armoring layers are comprised of metal and are produced by helically winding a longitudinal metal element. The antiwear polymer layer may be constructed by helically winding a tape comprised of a polyetherketoneketone in accordance with the present invention.

In still another embodiment, the flexible composite pipe may comprise a pressure vault and an armoring layer separated by an antiwear polymer layer comprised of polyetherketoneketone in accordance with the present invention. The pressure vault may be produced by helically winding a profiled metal wire with a short pitch.

To form a polymer layer, a polymeric composition containing polyetherketoneketone may be extruded. For example, pellets or a powder of the polymeric composition may be heated to a temperature effective to soften or melt the polymeric composition sufficiently to permit it to be passed through a die in an extruder and directly formed into a tube or sheath surrounding an inner layer of the flexible composite pipe, such as an armoring layer. Alternatively, the polymeric composition may be extrusion molded to form a long, relatively thin sheet. This sheet may be slit to obtain tapes that can then be wound in a helical fashion around another layer of the flexible composite pipe. In yet another embodiment, unidirectional prepreg tapes comprised of polyetherketoneketone impregnated onto carbon or glass fibers could be utilized, especially where it is desired to maximize the strength of a pressure managing layer. The edges of the helically wound tapes may be butted together and bonded using welding techniques, such as ultrasonic welding. The present invention has the advantage that the polyetherketoneketone provides a polymer layer exhibiting exceptionally good self-adhesion, such that individual sections, layers or portions comprised of the polyetherketoneketone are readily fusible. This is particularly true where the polyetherketoneketone is amorphous or has a relatively low level of crystallinity.

The flexible pipe of the present invention may have any of the composite (layered) structures known in the art, with the difference being that at least one polymer layer in such structure comprises (or consists essentially of or consists of) an amorphous to semi-crystalline polyetherketoneketone or polyetherketoneketone mixture containing repeating units represented by Formula I and Formula II:

-A-C(═O)—B—C(═O)— I

A-C(═O)-D-C(═O)— II

where A is a p,p′-Ph-O-Ph- group, Ph is a phenylene radical, B is p-phenylene, and D is m-phenylene and wherein the Formula I:Formula II ratio is selected so as to impart sufficient ductility to said polymer layer to permit the flexible composite pipe to be wound on a spool without cracking.

Illustrative suitable flexible composite pipe structures which can be adapted to the present invention include, but are not limited to, those described in the following applications and patents, each of which is incorporated herein by reference in its entirety: WO 2008/113362; U.S. Pat. No. 6,857,452; US 2008/0190507; U.S. Pat. No. 5,601,893; WO 2008/119677; US 2007/0036925; U.S. Pat. No. 7,055,551; U.S. Pat. No. 5,730,188; U.S. Pat. No. 6,978,806; U.S. Pat. No. 6,668,866; and U.S. Pat. No. 7,302,973.

Flexible composite pipes in accordance with the present invention are useful in a wide variety of end-use applications, but are especially suitable for use in off-shore applications such as the transportation of oil and gas products from a drilling site to a host oil or gas platform. They may also be employed for the injection of chemicals into a sub-sea drilled well, where the pipe is connected between a host platform and a sub-sea satellite installation. The present invention provides pipes that are capable of operating at relatively high pressures and that are remarkably resistant to both the fluids or gases they are conveying (hot and/or corrosive oil, gases, chemicals) as well as the harsh environment they are placed in (salt water, for example). At the same time, the pipes are sufficiently flexible to be capable of being repeatedly spooled onto and off of a drum or reel (which is typically about 3 to about 8 meters in diameter) without cracking or losing their structural integrity. Other applications where the flexible composites of the present invention may be employed include modular chemical process environments, field-forward military, disaster relief and other situations where reconfigurable/redeployable high pressure piping is required but where support infrastructures for conventional pipe laying and joining are unavailable or unsuitable.

### EXAMPLES

### Example 1

### Production of a PEKK Inner Liner

A low T/I ratio, amorphous grade, of Polyetherketoneketone, PEKK (such as OXPEKK SP from Oxford Performance materials) is dried overnight at 120° C. and then extruded on 4 inch single screw Davis Standard extruder, fitted with a pipe die, running at 20-60 RPM and heated to 315° C. for the feed zone, 320° C. for the middle zone and 330° C. for the final zone, adapter and die. The pipe produced is cooled quickly in a hot air stream or warm water bath to harden the pipe. The pipe produced can be varied in diameter and thickness as desired. Unlike other polymers with high use temperatures and high chemical resistance, a low T/I ratio (55/45 to 65/35, but most preferably 60/40) PEKK will produce an amorphous polymer that will be flexible enough for spooling onto a spool as the pipe is produced. By adjusting the T/I ratio of the PEKK the modulus can be changed to provide higher use temperatures but lower flexibility of the pipe.

After cooling, the pipe can be overcoated with other polymers or layers of helical windings of tapes and/or of profiled metal wires or bands.

### Example 2

### Coextrusion of PEKK as an Antiwear Layer Between the Metal Helical Wires

In this construction a preformed pipe, similar to that described in Example 1, with an inner liner and at least one helical winding of profiled wire armor, is over-coated with a layer of PEKK in a process similar to that described in Example 1 but using a special die where the preformed pipe enters and is coated with a second polymer. As above the pipe can then be covered with a second layer of helical metal wire armor, which is usually wound in the opposite direction.

### Example 3

### Application of a Helically Wound PEKK Antiwear Layer Between the Metal Helical Wires

In this construction a preformed pipe, similar to that described in Example 1, with an inner liner and at least one helical winding of profiled wire armor, is over-coated with a layer of PEKK by helically winding a prefabricated PEKK tape over the metal wires. The PEKK tape is produced by extrusion with conditions similar to those described for the pipe in Example 1 but using a narrow (4 inch or less) sheet die and a smaller (2 inch) extruder. However, the conditions for the extrusion and the temperature profile of the extruder and the die would be similar to those in Example 1. Here again, the grade of PEKK can be modified to change the stiffness by using a high T/I ratio PEKK (70/30 or even higher) or made more flexible by lowering the T/I ratio, to 60/40 or even 55/45). The thermoplastic PEKK tape is heated during the winding process using a stream of hot air or hot nitrogen at 150-200° C. or even hotter if needed. This will soften the amorphous PEKK and allow it to knit at the edges of the tape. As above the pipe can then be covered with a second layer of helical metal wire armor either immediately after the application of the PEKK antiwear layer or the pipe can be spooled and the second layer of armor added at a later time.

### Example 4

### The Use of PEKK as an Outer Sheath of a Flexible Pipe

Amorphous PEKK is also suitable for use as an exterior sheath of the pipe construction. This is best applied by extruding the PEKK over the top of the preformed multilayered pipe construction similar to the process described in example 2. However, the sheath can also be produced by winding a tape of PEKK, with or without reinforcing fibers, over the preformed pipe construction while heating the tape to make it compliant and also heating the wound pipe to better seal the PEKK at the junction of the tapes as described in Example 3.

What is claimed is:

1. A flexible composite pipe comprising a plurality of layers including at least one polymer layer that is comprised of an amorphous to semi-crystalline polyetherketoneketone or polyetherketoneketone mixture containing repeating units represented by Formula I and Formula II:
-A-C(═O)—B—C(═O)— I
-A-C(═O)-D-C(═O)—II
where A is a p,p′-Ph-O-Ph- group, Ph is a phenylene radical, B is p-phenylene, and D is m-phenylene and wherein the Formula I:Formula II ratio is selected so as to impart sufficient ductility to said polymer layer to permit the flexible composite pipe to be wound on a spool without cracking.

2. The flexible composite pipe of claim 1, wherein the Formula I:Formula II ratio is from about 85:15 to about 55:45.

3. The flexible composite pipe of claim 1, wherein said polymer layer does not contain any polymer other than said polyetherketoneketone or polyetherketoneketone mixture.

4. The flexible composite pipe of claim 1, wherein said flexible composite pipe additionally comprises at least one armoring layer that is not bonded to said polymer layer.

5. The flexible composite pipe of claim 1, wherein said polymer layer is directly extruded onto an armoring layer.

6. The flexible composite pipe of claim 1, wherein said polymer layer is a wound layer.

7. The flexible composite pipe of claim 1, wherein said polymer layer is additionally comprised of at least one filler.

8. The flexible composite pipe of claim 1, wherein said polymer layer is additionally comprised of at least one fiber.

9. The flexible composite pipe of claim 1, wherein the flexible composite pipe is comprised of a plurality of layers and at least some of said layers are independent from each other.

10. The flexible composite pipe of claim 1, wherein the polymer layer has been obtained by helically winding a tape comprised of the polyetherketoneketone or polyetherketoneketone mixture.

11. The flexible composite pipe of claim 1, wherein the polyetherketoneketone or polyetherketoneketone mixture is amorphous.

12. The flexible composite pipe of claim 1, wherein the polymer layer has been obtained by extrusion.

13. The flexible composite pipe of claim 1, wherein the polyetherketoneketone or polyetherketoneketone mixture has a Tg of from about 150 to about 180 degrees C.

14. The flexible composite pipe of claim 1, wherein the polyetherketoneketone or polyetherketoneketone mixture has an elongation at break, as measured by ASTM D638, of at least 10%.

15. The flexible composite pipe of claim 1, wherein the polyetherketoneketone or polyetherketoneketone mixture is a mixture of polyetherketoneketones having different Formula I:Formula II ratios.

16. The flexible composite pipe of claim 1, wherein the polymer layer is an anti-wear layer.

17. The flexible composite pipe of claim 1, wherein the polymer layer is an internal pressure sheath.

18. The flexible composite pipe of claim 1, wherein the polymer layer is an outer sheath.

19. The flexible composite pipe of claim 1, wherein the polymer layer is an intermediate sheath.

20. The flexible composite pipe of claim 1, wherein the polyetherketoneketone or polyetherketone mixture has a crystallinity, as measured by DSC, of from 0 to about 50%.
